(19) United States
(12) Patent Application Publication
(10) Pub. No.: US 2010/0191158 A1
(43) Pub. Date: Jul. 29, 2010

(54) THERAPEUTIC PEBBLE SPA BED

(76) Inventors: Ira Harris Leventhal, San Jose, CA (US); Patricia Leigh Damron, Santa Cruz, CA (US)

Correspondence Address: IRA HARRIS LEVENTHAL, 3591 SUNNYMEAD CT, SAN JOSE, CA, 95117-2969, US

(21) Appl. No.: 12/692,112

(22) Filed: Jan. 22, 2010

Related U.S. Application Data
(60) Provisional application No. 61/147,121, filed on Jan. 25, 2009.

(51) Int. Cl. A61H 7/00

(52) U.S. Cl. 601/15; 601/131

(57) ABSTRACT

A therapeutic pebble spa bed includes a bed frame filled with pebble-shaped massaging media and an element for heating the massaging media. Heat therapy and natural massaging action from the textured, conforming massaging media are provided to the user. Powered massaging elements embedded in the massaging media provide additional types of massage therapy. Other elements can be added to the spa bed to provide tanning, auditory, visual, and audio-visual therapies. One embodiment of the device includes a closed-loop water heating system to heat the massaging media. Other embodiments are described and shown.

### CROSS-REFERENCE TO RELATED APPLICATIONS

This application claims the benefit of provisional patent application Ser. No. 61/147,121, filed 2009 Jan. 25 by the present inventors.

### BACKGROUND

### Prior Art

The following is a tabulation of some prior art that presently appears relevant:

### U.S. Patents

| Pat. Num. | Kind Code | Issue Date | Patentee |
|---|---|---|---|
| 1,844,247 | A | 1932 Feb. 09 | Freemon |
| 3,085,568 | A | 1963 Apr. 16 | Whitesell |
| 3,872,526 | A | 1975 Mar. 25 | Betts |
| 3,974,532 | A | 1976 Aug. 17 | Ecchuya |
| 4,167,940 | A | 1979 Sep. 18 | Ruf |
| 4,329,981 | A | 1982 May 18 | Dungl |
| 4,663,516 | A | 1987 May 05 | Blum |
| 5,008,965 | A | 1991 Apr. 23 | Vrzalik |
| 5,490,821 | A | 1996 Feb. 13 | Wu |
| 5,889,923 | A | 1999 Mar. 30 | Lee et al. |
| 6,139,568 | A | 2000 Oct. 31 | Doty |
| 6,723,059 | B1 | 2004 Apr. 20 | Park |
| 6,913,572 | B2 | 2005 Jul. 05 | Licht et al. |
| 7,311,683 | B2 | 2007 Dec. 25 | Turell et al. |

### U.S. Patent Applications

| Publ. Number | Kind Code | Publ. Date | Applicant |
|---|---|---|---|
| 2004/0153011 | A1 | 2004 Aug. 05 | Noguchi et al. |
| 2005/0187496 | A1 | 2005 Aug. 25 | Ho |
| 2006/0112490 | A1 | 2006 Jun. 01 | Chausse |

### Nonpatent Literature Documents

JTL Enterprises, Inc., http://www.hydromassage.com/General-Hydromassage-Bed.htm, “The HydroMassage Bed”.
Simulated Environment Concepts, Inc., http://www.spacapsule.com/home.php?page=Spa_Capsule, “SpaCapsule/Products/Spa Capsule”.
Therasage, LLC, http://www.therasage.com/SearchResults.asp?Cat=1, “Products->Massage Beds”.
Migun USA Corp., http://www.migunworld.com/products.php, “Products Info->Features of HY7000-UM”.
Nuga, Inc., http://www.nugabest.tv/global/bbs/board.php?bo_table=002&wr_id=1, “Products->Nuga Best NM 5000”.
About.com, http://spas.about.com/od/hotstonemassage/a/Hotstone.htm, “What Is Hot Stone Massage?”.

Therapeutic modalities that promote relaxation and provide various health benefits are very popular throughout the world. Several familiar examples are massage, heat, and tanning therapies. Auditory, visual, and olfactory therapies are also employed to promote relaxation and good health. A key goal of these therapies is to provide a stimulating and soothing experience for the user, to facilitate short and long term improvements in physical and mental health. To achieve this goal, combinations of the following techniques have been employed:
(a) Full-body therapy where the therapeutic modality is applied to a large portion of the user's body at once.
(b) Simulations of soothing natural experiences such as the feel of natural surfaces such as stones against the skin, the sound of ocean waves, and the warmth and light of the sun.
(c) Support surfaces and mediums that conform to the natural shape of the body and apply even pressure and therapeutic treatment across the body

There are numerous products that provide these types of therapies, such as beds, pads, or handheld devices that provide a massaging or heating action, heat lamps, and tanning beds.

Some handheld devices, such as in U.S. Pat. No. 1,844,247, combine heat and massage in a single unit. There is also a type of massage therapy known as Hot Stone Massage (http://spas.about.com/od/hotstonemassage/a/Hotstone.htm) where natural stones are heated and placed at specific locations on a person's body. These devices and methods have the limitation that they apply therapy to only a small portion of the body.

There are also a number of devices designed to apply therapies to a person's feet. Some of these devices, such as in U.S. Pat. Nos. 4,167,940, 4,329,981, and 5490821, provide massage therapy only, using surfaces with pebble-like protrusions. The device described in U.S. patent application 2005/0187496 provides massage therapy using moving surfaces with pebble-like protrusions and heat therapy with a heated water bath. Each of the foot therapy devices described above simulate a surface of pebbles using man-made materials, which does not provide the same experience and feel of natural pebbles against the skin. The pebble-like protrusions employed are also at fixed locations, so the massaging medium cannot conform completely to the shape of the user's foot. This can lead to issues such as uneven pressure against the foot and portions of the foot receiving insufficient massage therapy. A foot therapy device described in U.S. patent application 2004/0153011 provides massage therapy only, using a container filled with freely moving pebble-shaped massaging media that can be natural pebbles. All of these foot therapies are limited in the types of therapies that they provide, as well as being limited to providing therapeutic treatment to the feet only.

A variety of pads are available with protruding features that provide a natural massaging action when they contact a user's body. The surfaces of these pads are typically man-made, so they do not provide the same therapeutic experience as natural materials such as pebbles. An example is the pad described in U.S. Pat. No. 3,974,532, which provides a natural massaging action when the user lies on it, but does not provide any other types of therapy such as heat therapy. Also, the surfaces do not conform to the body as effectively as freely moving massaging media such as natural pebbles.

To achieve the goal of providing full-body therapy there are a variety of spa therapy beds currently commercially available, patented, or patent-pending. Many of these beds offer built-in massage, heat, or tanning therapies. In some cases these beds or capsules employ additional sensory therapies such as auditory, visual, or olfactory therapy. The bed described in U.S. Pat. No. 5,008,965 utilizes granular material to conform to a user's body, supporting it in various positions, but it does not provide any therapeutic treatments, and there is an insulating layer between the user and the granules, preventing a natural massaging effect. The bed described in U.S. Pat. No. 5,889,923 uses a natural stone surface to provide heat therapy, but the surface is solid and does not conform to a user's body or provide any type of massage therapy. The mattress described in U.S. patent application 2006/0112490 employs a surface of protrusions to provide a natural massaging action but does not provide other therapies such as heat therapy. The bed described in U.S. Pat. No. 4,663,516 employs a sand filling to provide heat therapy and conform to the user's body, but does not provide any type of massage therapy and requires an insulating textile layer between the user and the sand filling. The bed described in U.S. Pat. No. 6,723,059 employs a plurality of flexible rope elements as a conforming mattress surface and vibrating massage elements to provide massage therapy. However, no other therapies such as heat therapy are provided, and the rope elements do not provide the same natural massaging action and therapeutic experience as natural materials such as pebbles.

There are several commercially available beds that combine massage therapy and heat therapy by employing a mattress pad with built-in massaging and heating elements. Examples are the Therasage RS8000X Massage Bed (http://www.therasage.com/SearchResults.asp?Cat=1), the Migun HY-7000 UM Thermal Massage Bed (http://www.migunworld.com/products.php), and the Nuga Best NM 5000 (http://www.nugabest.tv/global/bbs/board.php?bo_table=002&wr_id=1). However, the surfaces of these beds are not fully conforming to the user's body, and the man-made surfaces used do not provide a natural massaging action or the same therapeutic experience as natural materials such as pebbles.

Another category of beds employ a conforming water-filled mattress and devices which provide therapeutic treatments, in some cases using the water in the mattress as the medium through which the treatments are transmitted to the user. The bed described in U.S. Pat. No. 3,085,568 provides both massage therapy and heat therapy through the water in the mattress. Other therapies, such as heat lamp therapy, light therapy, and auditory therapy, are also provided. However, the water-filled mattress surface does not provide a natural massaging action or the same therapeutic experience as natural materials such as pebbles. The bed described in U.S. Pat. No. 3,872,526 also employs a water-filled mattress with the same limitations described above as well as providing vibratory massage therapy only.

A stronger massaging action is provided by a category of beds that provide dry hydrotherapy by employing a tub of water, a plurality of liquid jets, and a conforming insulating layer to support the user above the water. The bed described in U.S. Pat. No. 7,311,683 uses this technique to provide massage therapy, but the insulating layer does not provide the same natural massaging action and therapeutic experience as natural materials such as pebbles. The HydroMassage Bed from JTL Enterprises (http://www.hydromassage.com/General-Hydromassage-Bed.htm) is one of the commercially available versions of this type of bed.

The Spa Capsule described in U.S. Pat. No. 6,913,572 and sold commercially by Simulated Environment Concepts, Inc. (http://www.spacapsule.com/home.php?page=Spa_Capsule), is a dry hydrotherapy bed that also includes auditory, visual, and olfactory therapies in a temperature-controlled capsule. However, as with the other dry hydrotherapy beds, the insulating layer does not provide the same natural massaging action and therapeutic experience as natural materials such as pebbles.

Tanning therapy is provided with tanning beds produced by a variety of manufacturers. The tanning beds typically are designed as described in U.S. Pat. No. 6,139,568, where the user lies in a clamshell-type bed with open ends, and both the top and bottom of the bed contain a plurality of tanning bulbs. These beds do not provide any other types of therapy such as massage therapy, and the heat provided is not controlled but simply a side-effect of the tanning bulbs. The user lies on a hard, man-made, non-conforming surface that does not provide any type of therapeutic experience such as natural massaging action.

As we have described, the patented and/or commercially available devices for providing massage therapy, heat therapy, and/or tanning therapy suffer from some or all of the following disadvantages:
(a) The devices often provide only a single type of therapy.
(b) Man-made surfaces are typically used which do not provide the same natural massaging action and therapeutic experience as natural materials such as pebbles.
(c) Therapy is sometimes limited to a small portion of the user's body.
(d) The surfaces often do not fully conform to the user's body.

Due to these limitations, there is no device currently available or defined in the prior art which provides multiple therapeutic modalities such as combined massage therapy and heat therapy, provides a surface that fully conforms to the user's body, employs a natural material such as pebbles which provides a natural massaging action, and provides the included therapies to the user's entire body.

### SUMMARY

In accordance with one embodiment, a therapeutic pebble spa bed consists of a box-like bed frame which contains a bed of pebbles which are heated and cleaned using a variety of techniques. The user lies on the bed of pebbles and can enjoy a variety of therapeutic treatments including heat therapy, the natural massaging action of the pebbles, and stimulating massage transmitted through the pebbles from a massaging apparatus to the user's body. A cover fitted with ultraviolet tanning lights can be positioned over the user to provide tanning therapy. The cover can be closed over the therapeutic pebble spa bed when not in use, or for cleaning with steam jets.

### ADVANTAGES

Accordingly several advantages of one or more aspects are as follows: The bed of pebbles is pre-heated for the user to lie on, the warm pebbles provide a natural massaging action to the user, the multi-motion massage element provides selectable massage actions through the pebbles to the user's body, the pebbles conform to the user's body and provide therapy to a large portion of the body, audio and visual effects included in the therapeutic pebble spa bed enhance the user's relaxation experience, the user can receive tanning while using the therapeutic pebble spa bed, steam nozzles can provide fast, easy and safe cleaning of the therapeutic pebble spa bed while the cover is closed, and the therapeutic pebble spa bed can be augmented with or integrated into a wet or dry sauna environment. Other advantages of one or more aspects will be apparent from a consideration of the drawings and ensuing description.

### DRAWINGS

### Figures

In the drawings, closely related figures have the same number but different alphabetic suffixes.

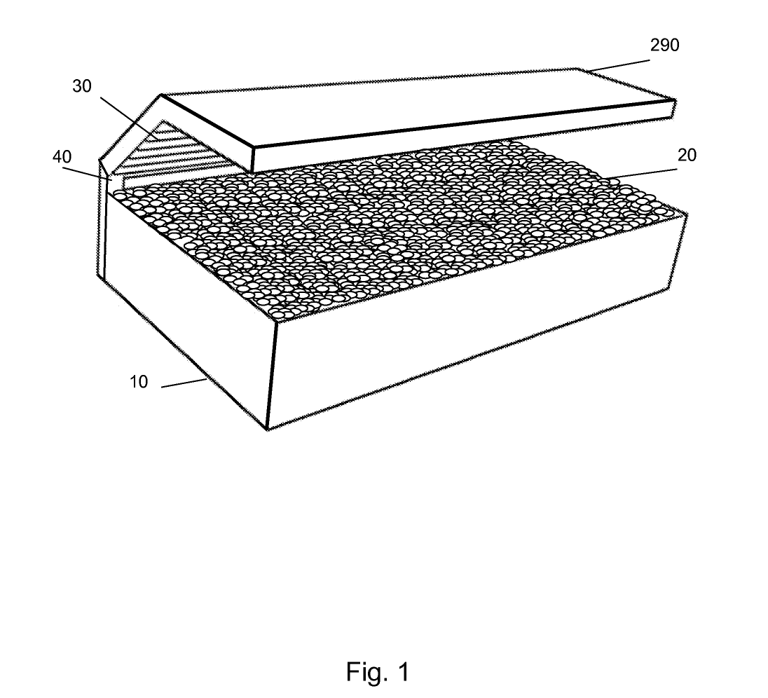

FIG. 1 shows a perspective view of a therapeutic pebble spa bed in accordance with one embodiment in which the pebbles may be preheated and the tanning equipment is positioned above the user so that the user can receive tanning treatment while enjoying the natural or mechanical massaging action of the therapeutic pebble spa bed.

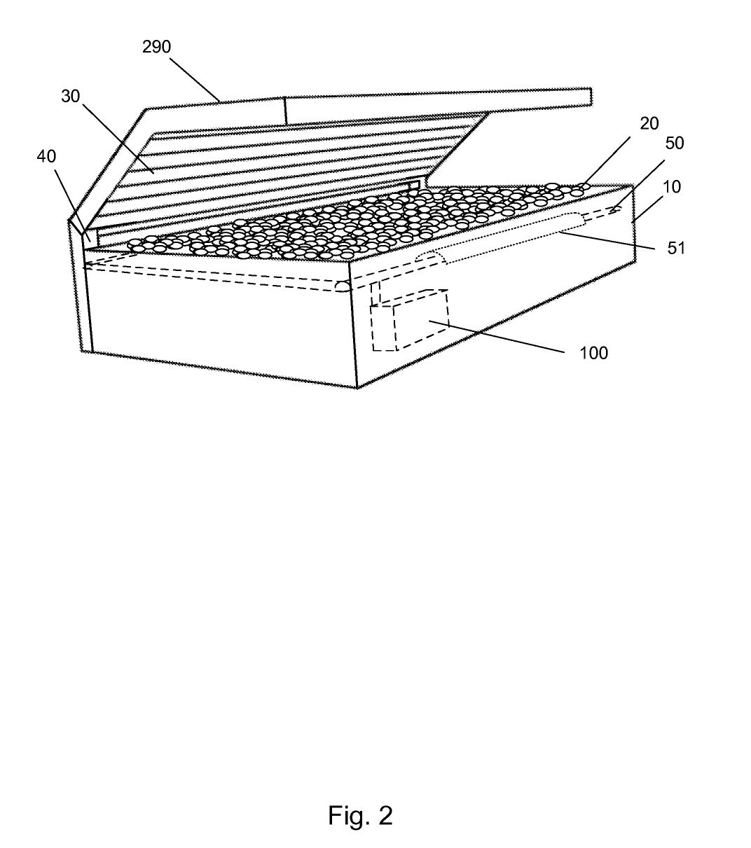

FIG. 2 shows the same view and embodiment as in FIG. 1, with a heater to heat water for running through pipes which provide conductive heat to the pebbles, and a heat shield (shown in partial view so as to illustrate the structure of the heated water pipe) to separate the complete length of the hot pipe surface from the user.

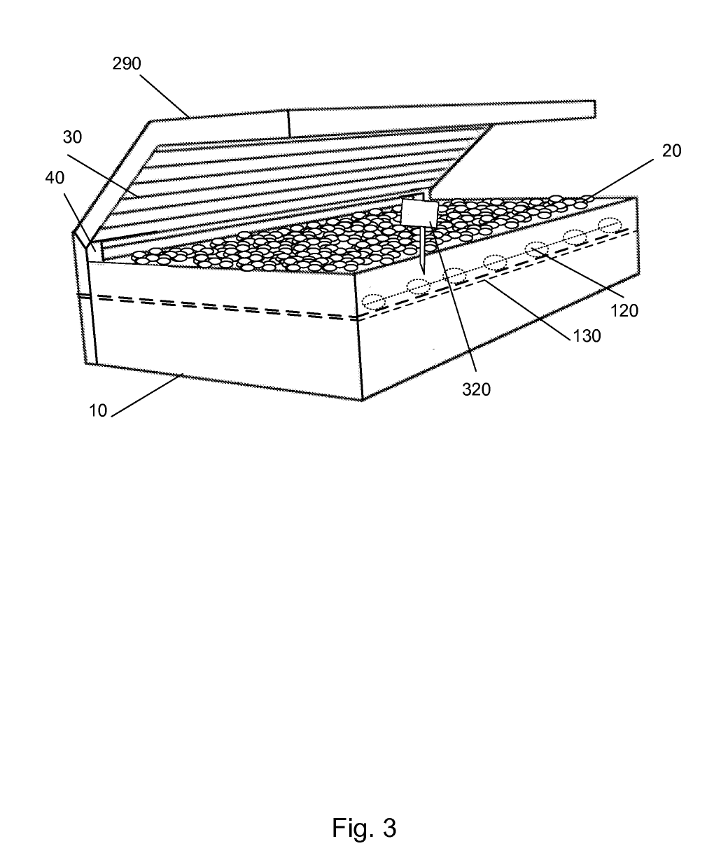

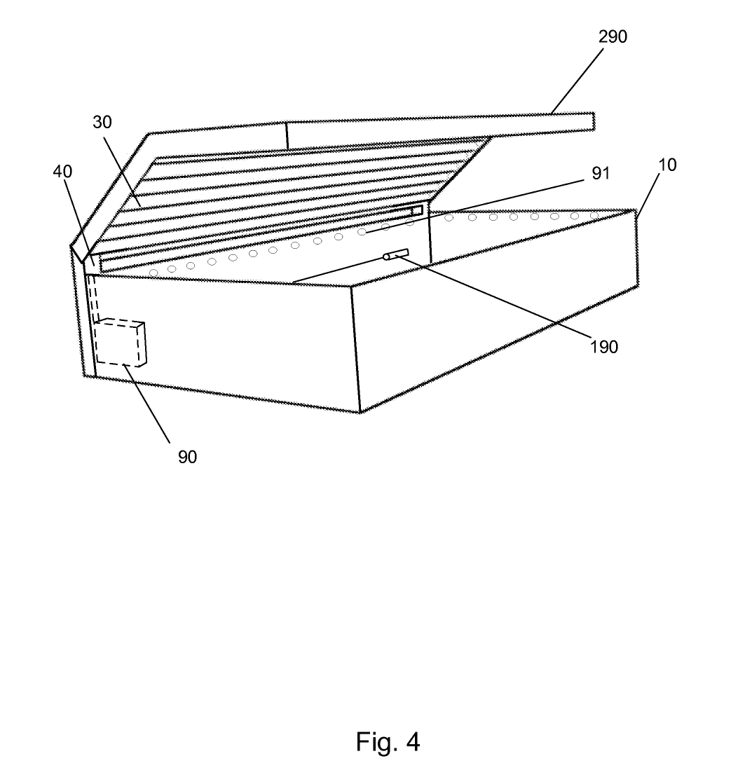

FIG. 3 shows a the same view and embodiment as in FIG. 1, with an attached control panel and a multi-motion massage element embedded in the pebbles, resting on a support, for use in providing selectable massage motions to the user, transmitting the massage actions through the pebbles.

FIG. 4 shows a perspective view of a therapeutic pebble spa bed in accordance with the same view and embodiment as FIG. 1, showing ultraviolet lights for tanning, a temperature sensor, a steam boiler, and nozzles attached to the bed frame which produce steam for cleaning the bed of pebbles when the cover is closed and locked. FIG. 4 also illustrates a fourth embodiment where the steam is used as an alternate means to heat the bed of pebbles to provide heat therapy.

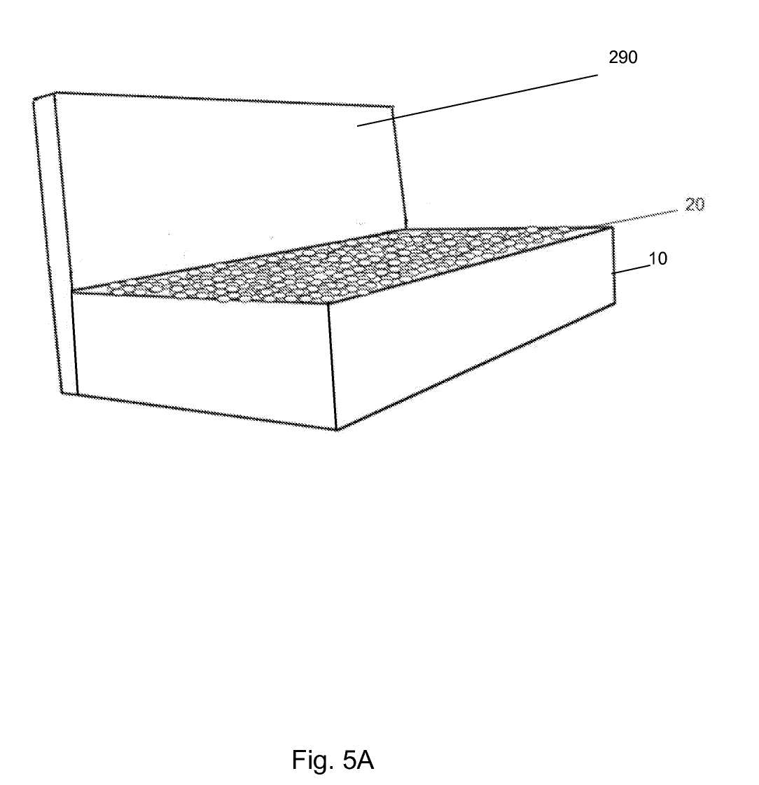

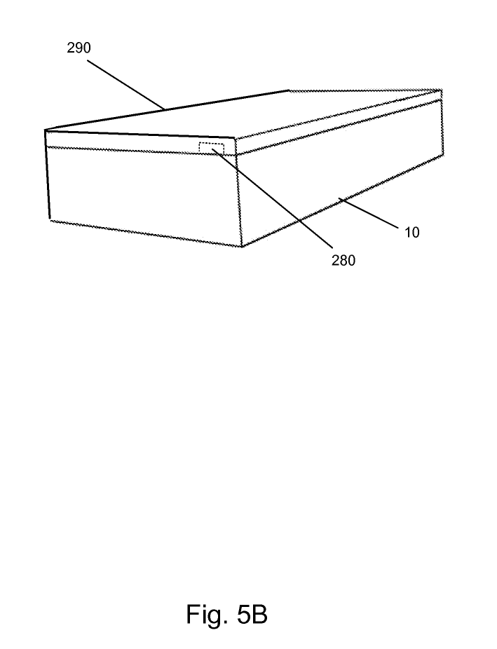

FIG. 5A shows the same view and embodiment as in FIG. 1, with the cover and tanning equipment shown folded into the storage position.

FIG. 5B shows the same view and embodiment as in FIG. 1, with the cover and tanning equipment shown in the closed, or cleaning position, such that steam jets or another cleaning action can be used to sanitize the bed of pebbles. A safety lock is used to ensure that the cover remains closed during the sanitization process.

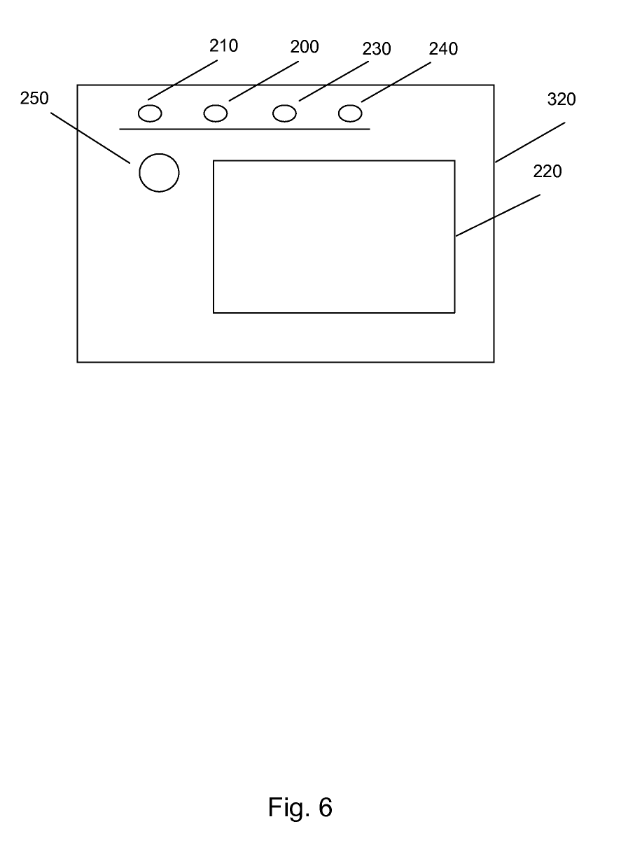

FIG. 6 shows a view of a control panel which contains controls for temperature, tanning intensity, and massage, as well as a timer, a power switch, and a status display. The control panel connects to the side of the therapeutic pebble spa bed, in accordance with the embodiment shown in FIG. 1.

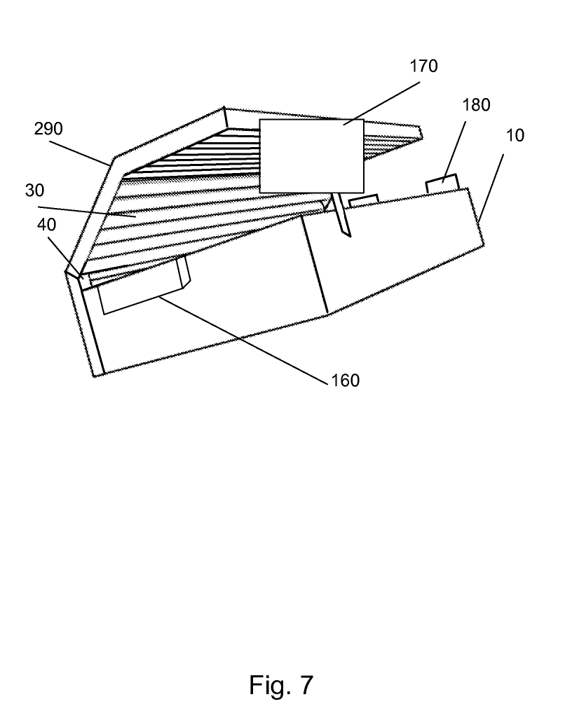

FIG. 7 shows the same view and embodiment as in FIG. 1, with audio-visual equipment integrated into the therapeutic pebble spa bed to provide therapy and entertainment to the user while the user enjoys the heated pebbles.

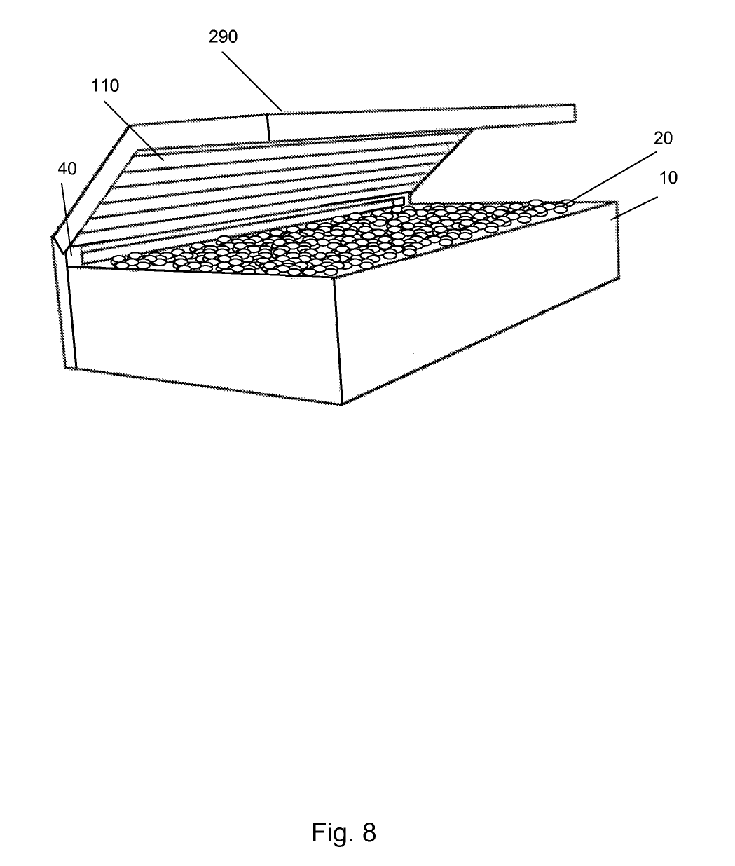

FIG. 8 shows a perspective view of the inside of the cover of the therapeutic pebble spa bed, in a second embodiment in which infrared heating elements in the cover are used to heat the pebbles.

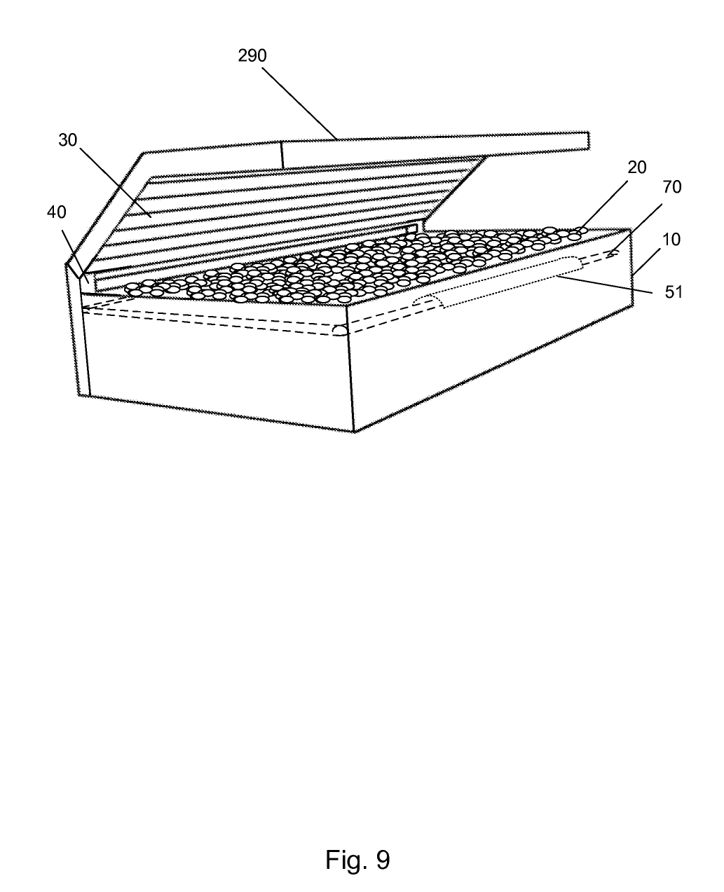

FIG. 9 shows a perspective view of the inside of the cover of the therapeutic pebble spa bed, in a third embodiment in which an electric heating element embedded in the bed of pebbles is used to heat the pebbles.

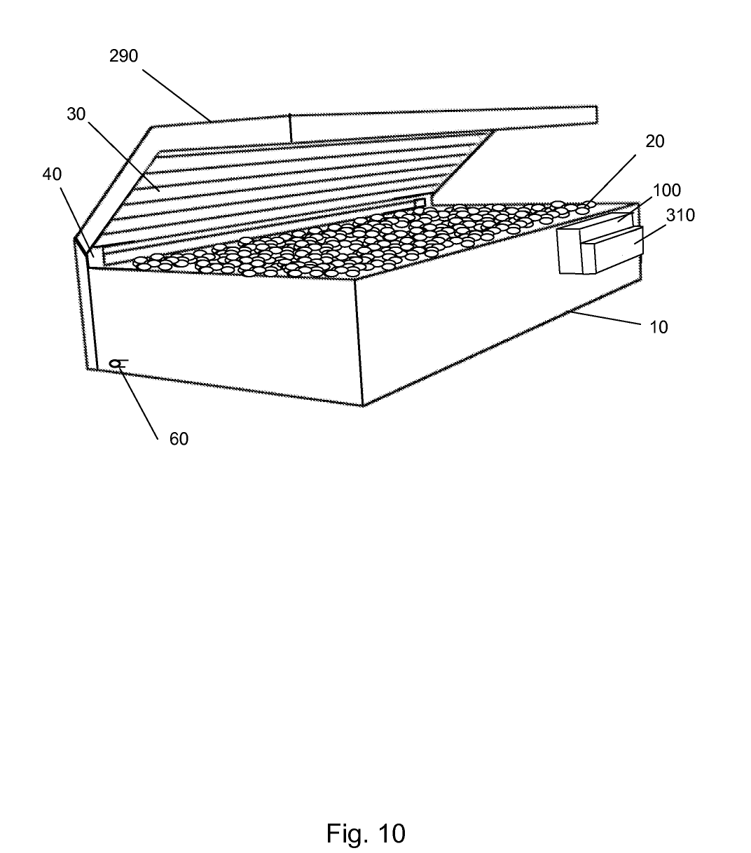

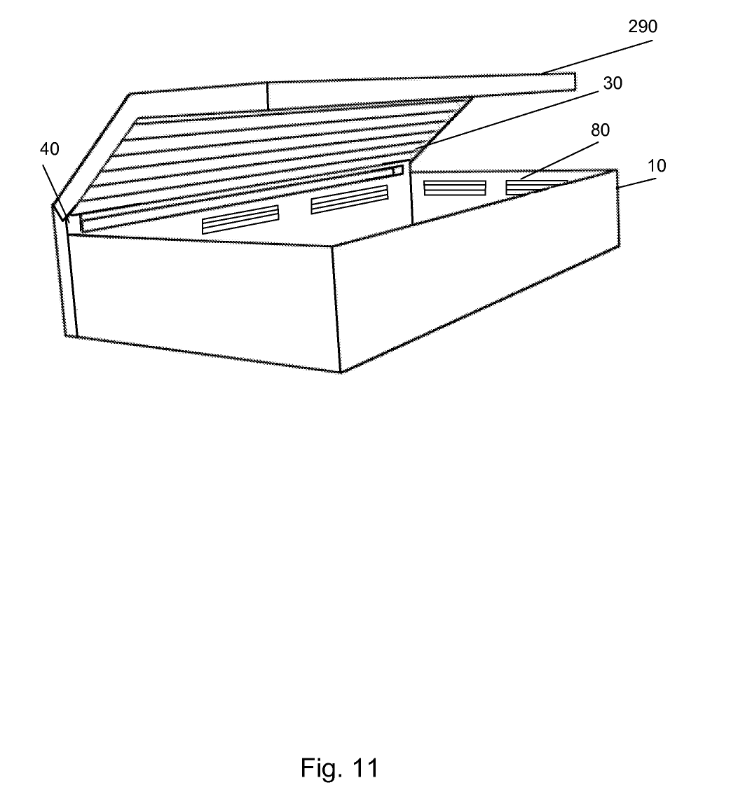

FIG. 10 shows a perspective view of a therapeutic pebble spa bed in a fifth embodiment which includes a heater to heat water that is used to flood the bed frame, heating the bed of pebbles by direct contact.

FIG. 11 shows a perspective view of the inside of the frame of the therapeutic pebble spa bed in a sixth embodiment in which forced-air heating elements embedded in the bed of pebbles are used to heat the pebbles.

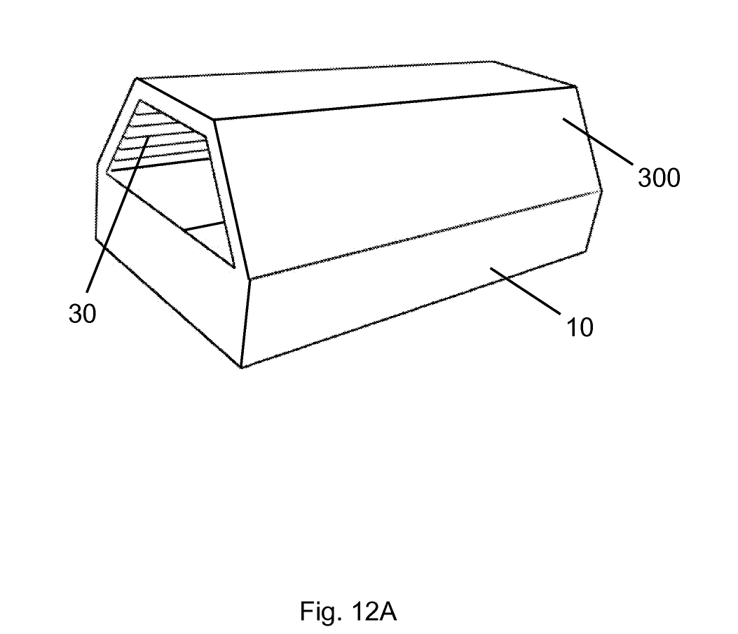

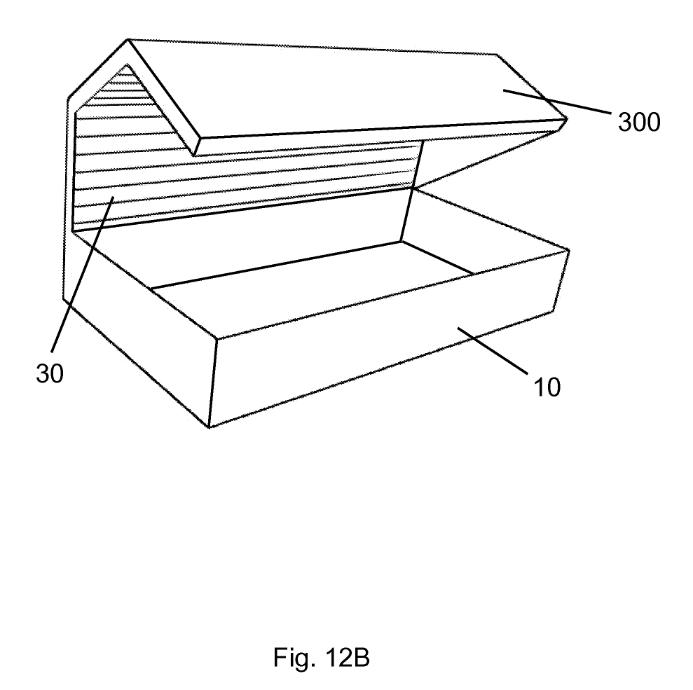

FIG. 12A shows a perspective view of the therapeutic pebble spa bed, in a seventh embodiment in which a domed cover partially encloses the therapeutic pebble spa bed.

FIG. 12B shows the same view and embodiment as FIG. 12A with the cover in the open position.

In some of the figures, in order to allow clearer illustration of some of the elements of the therapeutic pebble spa bed, the bed of pebbles is not shown.

### REFERENCE NUMERALS

| | |
|---|---|
| 10 | bed frame |
| 20 | bed of pebbles |
| 30 | ultraviolet light |
| 40 | support |
| 50 | pipe |
| 51 | heat shield |
| 60 | drain |
| 70 | electric heating element |
| 80 | forced air heater |
| 90 | steam boiler |
| 91 | steam nozzle |
| 100 | water heater |
| 110 | infrared heating element |
| 120 | massage element |
| 130 | massage element support |
| 160 | media source unit |
| 170 | video display |
| 180 | speaker |
| 190 | temperature sensor |
| 200 | thermostat |
| 210 | power switch |
| 220 | status display |
| 230 | tanning intensity control |
| 240 | timer control |
| 250 | massage control |
| 280 | safety lock |
| 290 | cover |
| 300 | domed cover |
| 310 | ozonator |
| 320 | control panel |

### DETAILED DESCRIPTION

### FIGS. 1, 2, 3, 4, 5B, 6, 7—First Embodiment

One embodiment of the therapeutic pebble spa bed is shown in FIGS. 1 and 2. A raised box-like bed frame 10 holds a bed of pebbles 20 which is heated by a conductive water heater 100 embedded in bed of pebbles 20. A cover 290 is held above bed frame 10 on a set of supports 40. The cover 290 contains a plurality of ultraviolet lights 30. A control panel 320 is connected to bed frame 10 (FIG. 3) and contains a power switch 210, a thermostat 200, a tanning intensity control 230, a timer control 240, a massage control 250 and a status display 220 (FIG. 6). A temperature sensor 190 is connected to bed frame 10 and embedded in bed of pebbles 20 to measure its temperature (FIG. 4). A series of pipes 50 which circulate the water that is pumped by water heater 100 are embedded in bed of pebbles 20 and covered by a heat shield 51 to protect the user from inadvertent direct contact with heated pipes 50 (FIG. 2). A multi-motion massage element 120 is also embedded in bed of pebbles 20 and is connected to bed frame 10 with a massage element support 130 (FIG. 3). The bed frame 10 also contains a steam boiler 90 and a plurality of steam nozzles 91 for sanitizing bed of pebbles 20 (FIG. 4). A safety lock 280 on bed frame 10 holds cover 290 in closed position when required (FIG. 5B). A media source unit 160 transmits audio and/or video signals to a video display 170 and a set of speakers 180 mounted on bed frame 10 (FIG. 7).

### Operation

### FIGS. 1, 2, 3, 4, 5A, 5B, 6, 7

A typical mode of operation of this embodiment of the device is as follows: cover 290 is lowered over bed of pebbles 20 on supports 40 to the closed position (FIG. 5B). The user turns on power switch 210 (FIG. 6) to activate conductive hot water heater 100 to quickly heat bed of pebbles 20 to the desired temperature (FIG. 2). The user can set the desired temperature using thermostat 200. During the heating cycle, status display 220 displays the word “Heating”, the desired temperature as set with thermostat 200, and the current temperature measured by temperature sensor 190 (FIG. 4). Once the desired temperature is reached, as measured by temperature sensor 190, water heater 100 is shut off. The status display 220 then displays the words “Ready for Therapy”, as well as continuing to display the desired and current temperatures. The cover 290 is folded and stored by the side of bed frame 10 if no tanning is desired (FIG. 5A). If tanning is desired, cover 290, fitted with ultraviolet lights 30, is positioned on supports 40 to a height sufficient to be used for tanning therapy (FIG. 1). The user then lies down on bed of pebbles 20 and enjoys the natural massaging action and heat therapy from bed of pebbles 20.

If ultraviolet lights 30 are in tanning position, the person receives tanning therapy by setting the desired tanning intensity using tanning intensity control 230 and the length of the tanning session using timer control 240. The tanning intensity and time remaining in the tanning session are displayed on status display 220.

If additional massage therapy is desired, the user selects the type and intensity of the therapy with massage control 250. The massage element 120, mounted on massage element support 130, imparts a variety of massaging motions and vibrations to the user that are transmitted through bed of pebbles 20 (FIG. 3).

If audio and/or visual therapy is desired, the user selects the desired programming on media source unit 160, watches the video programming on video display 170 and listens to the audio programming on speakers 180 (FIG. 7).

After the therapy session has been completed, ultraviolet lights 30 are turned off if they were used for tanning therapy. After the user exits the therapeutic pebble spa bed, cover 290 is then lowered on supports 40 to the surface of bed of pebbles 20 and steam nozzles 91 emit steam to sanitize bed of pebbles 20 prior to the next therapy session (FIG. 4). To initiate the sanitization process, the user turns power switch 210 to the “Sanitize” setting, and the word “Sanitizing” as well as the time remaining in the sanitization cycle are displayed on status display 220. During the sanitization process safety lock 280 is engaged to prevent cover 290 from being raised from bed of pebbles 20 while it is too hot for safe contact with skin. After a preset sanitization period has completed, the word “Cooling” is displayed on status display 220. Once the temperature of bed of pebbles 20 cools back down to the desired temperature as measured by temperature sensor 190, the words “Ready for Therapy” will be displayed, safety lock 280 is disengaged, cover 290 can be raised, and another therapy session can start.

### FIG. 8

### Second Embodiment

An additional embodiment is shown in FIG. 8. In this embodiment a plurality of infrared heating elements 110 are used as an alternate means to heat bed of pebbles 20.

### FIG. 9

### Third Embodiment

An additional embodiment is shown in FIG. 9. In this embodiment an electric heating element 70 is used as an alternate means to heat bed of pebbles 20. Protection for the user from direct contact with electric heating element 70 is provided by heat shield 51.

### FIG. 4

### Fourth Embodiment

An additional embodiment is shown in FIG. 4. In this embodiment steam nozzles 91 are used as an alternate means to heat bed of pebbles 20, in addition to being used to sanitize bed of pebbles 20. This embodiment differs from the first embodiment because there is no water heater 100 included.

### FIG. 10

### Fifth Embodiment

An additional embodiment is shown in FIG. 10. In this embodiment water heater 100 is used to flood bed frame 10 with heated water as an alternate means to heat bed of pebbles 20. Once the heating process is completed, the water is emptied from bed frame 10 through a drain 60. Sanitizing chemicals can be added to the water, or an ozonator 310 can be used, as alternate means for sanitizing bed of pebbles 20.

### FIG. 11

### Sixth Embodiment

An additional embodiment is shown in FIG. 11. In this embodiment a plurality of forced air heaters 80 are used as an alternate means to heat bed of pebbles 20.

### FIGS. 12A, 12B

### Seventh Embodiment

An additional embodiment is shown in FIGS. 12A and 12B. In this embodiment a domed cover 300 is connected to bed frame 10. When domed cover 300 is in the closed position (FIG. 12A) an enclosed area is created around the user where a dry or wet sauna environment can be maintained. The domed cover 300 can be opened to allow the user to access bed frame 10 (FIG. 12B).

### ADVANTAGES

From the description above, a number of advantages of some embodiments of our therapeutic pebble spa bed become evident:
(a) Multiple therapeutic modalities, such as combined massage, heat, and tanning therapy, are simultaneously provided to the user.
(b) The natural surface and texture of the pebbles combine to provide a natural massaging action.
(c) Heat, massage, and other therapies are provided across a large portion of the user's body.
(d) The bed of pebbles fully conforms to the user's body.
(e) The bed of pebbles is an excellent medium for storing heat that provides a long-lasting heat therapy session for the user.
(f) The multi-motion massage element provides selectable massage actions through the pebbles to the user's body and the bed of pebbles provides a firm yet flexible transmission of massaging action to user.
(g) The massaging actions provided are suitable for spa customers as well as for bed-bound people, to help promote blood circulation in the skin and superficial muscle tissues.
(h) Steam nozzles provide fast, easy, and safe cleaning of the bed of pebbles while the cover is closed.
(i) The bed is safe and easy to operate, including features such as a heat shield and a safety lock to prevent harm to the user during cleaning.
(j) The bed can be operated either by a user or by a spa therapist, with all controls easily within reach.
(k) The dimensions are similar to existing spa beds such as tanning beds.
(l) Auditory and/or visual therapy can be used to complement the physical therapeutic modalities.
(m) The optional domed cover allows a wet or dry sauna treatment to be provided for the user.

### CONCLUSION, RAMIFICATIONS, AND SCOPE

As shown in the various embodiments of the therapeutic pebble spa bed described here, our invention uses a bed of pebbles to provides a soothing, natural massaging action as well as heat therapy simultaneously to the user. These therapies can be augmented with powered massage therapy, tanning therapy, auditory and/or visual therapy, and dry or wet sauna treatments.

The bed is easy to operate, with all controls easily accessible to either the user or a therapist. Safe operation is provided by features such as the heat shield and the safety lock which prevents the cover from being opened during cleaning.

Although the description above contains many specificities, these should not be construed as limiting the scope of the embodiments but as merely providing illustrations of some of several embodiments. For example, the cover is not required if ultraviolet lights and infrared heating elements are not included and steam cleaning is not performed; the pebbles can be cooled instead of heated to provide a different type of temperature-based therapy; an alternate type of massaging media such as polished glass can be used to provide a similar natural massaging action; the placement of the video display and speakers can be changed; arrays of video displays and/or speakers can be used to provide an enhanced sensory experience; massage elements with different shapes and capabilities can be embedded in the bed of pebbles; alternate fluids such as oil can be used in place of water in the closed-loop heating system,

Thus the scope of the embodiments should be determined by the appended claims and their legal equivalents, rather than by the examples given.

We claim:

1. A therapeutic pebble spa bed, comprising:
(a) a box-like container which is open toward the top, and which contains a plurality of freely moving pebble-shaped massaging media, and
(b) a heating device that is connected to said box-like container and means for transferring heat from said heating device to said pebble-shaped massaging media,
whereby the user of said therapeutic pebble spa bed lies down on said pebble-shaped massaging media, and said pebble-shaped massaging media conforms to said user's body, provides a natural massaging action resulting from its irregular texture, and heats said user's body.

2. The device of claim 1 wherein said pebble-shaped massaging media is selected from the group consisting of natural pebbles, man-made pebbles, marbles, and mixtures thereof.

3. The device of claim 1 wherein said heating device is a fluid heating unit, comprising:
(a) a tank that is connected to said box-like container and contains fluid which is heated by an energy source selected from the group consisting of electric, oil, gas, and propane,
(b) a closed-loop system of pipes which is connected to said tank and contacts said pebble-shaped massaging media, and
(c) at least one pump connected in-line with said pipes,
whereby said fluid is heated by said energy source, pumped by said pump from said tank through said pipes, then flows back into said tank, such that said fluid heats said pipes which then heat said pebble-shaped massaging media.

4. The device of claim 1 wherein said heating device is a fluid heating unit, comprising:
(a) a tank that is connected to said box-like container and contains fluid which is heated by an energy source selected from the group consisting of electric, oil, gas, and propane,
(b) at least one pump connected to said tank, and
(c) at least one drain in bottom of said box-like container,
whereby said fluid is heated by said energy source, pumped by said pump from said tank into said box-like container where it comes in contact with and heats said pebble-shaped massaging media, and is then drained from said box-like container by opening said drains.

5. The device of claim 1 wherein said heating device is a steam heating unit, comprising:
(a) a tank that is connected to said box-like container and contains water which is boiled by an energy source selected from the group consisting of electric, oil, gas, and propane,
(b) at least one pipe which is connected to said tank, and
(c) at least one nozzle which is connected to one of said pipes and positioned in close proximity to said pebble-shaped massaging media,
whereby said water is boiled by said energy source and converted to steam which flows through said pipes and is released through said nozzles, heating said pebble-shaped massaging media.

6. The device of claim 1 wherein said heating device is an electric heating element that is positioned in contact with said pebble-shaped massaging media.

7. The device of claim 1 wherein said heating device is a forced-air heater which blows hot air onto said pebble-shaped massaging media.

8. The device of claim 1, further including a massaging element which is contained in said box-like container and contacts said pebble-shaped massaging media.

9. The device of claim 8 wherein said massaging element is a motorized, moving massage element, comprising:
(a) a motor connected to said box-like container,
(b) at least one rigid mass that contacts said pebble-shaped massaging media, and
(c) means for coupling said motor to said rigid masses,
whereby said motor moves said rigid masses in a motion selected from the group consisting of vibratory, percussive, horizontal, vertical, and mixtures thereof, and said rigid masses move said pebble-shaped media in a similar motion.

10. The device of claim 1, further including vertical supporting members connected to said box-shaped container and a cover for said box-shaped container that is connected to said vertical supporting members, whereby said cover can be closed or opened and held above said box-shaped container by said supporting members.

11. The device of claim 10, wherein said heating device is a plurality of heating elements that are connected to the underside of said cover, whereby said heating elements emit infrared radiation that is directed to and absorbed by said pebble-shaped massaging media.

12. The device of claim 10, further including a plurality of ultraviolet tanning lamps that are connected to the underside of said cover, whereby said ultraviolet tanning lamps emit ultraviolet radiation that is directed to said pebble-shaped massaging media such that said user is exposed to said ultraviolet radiation.

13. The device of claim 10 wherein said cover has a domed shape whereby, when said cover is in its closed position, said box-shaped container and said cover form an enclosed space around said user, such that within said enclosed space, environmental factors selected from the group consisting of temperature, humidity, and mixtures thereof can be maintained.

14. The device of claim 1, further including a media presentation system, comprising:
(a) at least one output device selected from the group consisting of speaker, video display, and mixtures thereof, connected to said box-like container,
(b) at least one media source selected from the group consisting of audio source, video source, audio-visual source, and mixtures thereof, connected to said box-like container, and
(c) means for transmitting signals from said media sources to said output devices,
whereby said user receives sensory stimulation.

15. A therapeutic pebble spa bed, comprising:
(a) a box-like container which is open toward the top, and which contains a plurality of freely moving pebble-shaped massaging media, and
(b) a cooling device that is connected to said box-like container and means for transferring cold from said cooling device to said pebble-shaped massaging media,
whereby the user of said therapeutic pebble spa bed lies down on said pebble-shaped massaging media, and said pebble-shaped massaging media conforms to said user's body, provides a natural massaging action resulting from its irregular texture, and cools said user's body.

16. The device of claim 15, further including a motorized, moving massage element, comprising:
(a) a motor connected to said box-like container,
(b) at least one rigid mass that contacts said pebble-shaped massaging media, and
(c) means for coupling said motor to said rigid masses,
whereby said motor moves said rigid masses in a motion selected from the group consisting of vibratory, percussive, horizontal, vertical, and mixtures thereof, and said rigid masses move said pebble-shaped media in a similar motion.

17. A method for providing a spa treatment, comprising
(a) using a heating device, that is connected to a box-like container which is open toward the top, to heat a plurality of freely moving pebble-shaped massaging media that are contained in said box-like container, and
(b) having a user lie down on said pebble-shaped massaging media,
whereby said user receives a combination of heat therapy from the stored heat in said pebble-shaped massaging media and natural massaging action resulting from the irregular texture and conforming nature of said pebble-shaped massaging media.

18. The method of claim 17, further including using a powered massaging element, which is contained in said box-like container and contacts said pebble-shaped massaging media, to provide additional massage therapy that is transmitted through said pebble-shaped massaging media to said user.

19. The method of claim 17, further including using a plurality of ultraviolet tanning lamps which are suspended above said pebble-shaped massaging media to provide tanning therapy to said user.

20. The method of claim 17 wherein said heating device is selected from the group consisting of fluid heating unit, steam heating unit, electric heating element, forced air heater, infrared heating element, and mixtures thereof.
